(19) United States
(12) Patent Application Publication
(10) Pub. No.: US 2013/0272280 A1
(43) Pub. Date: Oct. 17, 2013

(54) Inter-System Carrier Aggregation

(71) Applicants: Pasi Eino Tapio Kinnunen, Oulu (FI); Antti Anton Toskala, Espoo (FI)

(72) Inventors: Pasi Eino Tapio Kinnunen, Oulu (FI); Antti Anton Toskala, Espoo (FI)

(73) Assignee: Nokia Siemens Networks Oy, Espoo (FI)

(21) Appl. No.: 13/976,648

(22) PCT Filed: Dec. 27, 2010
(86) PCT No.: PCT/EP10/70743

§ 371 Date: Jun. 27, 2013

(51) Int. Cl. H04W 72/04

(52) U.S. Cl. CPC H04W 72/04
USPC 370/336; 370/329

(57) ABSTRACT

The invention relates to apparatuses, a method, computer program and computer-readable medium.

### FIELD

The invention relates to apparatuses, a method, computer program, computer program product and a computer-readable medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context. Recently a need for enhanced data transfer has become a hot topic.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: obtain data to be transmitted in downlink; provide a part of the data to be transmitted in downlink to a node apparatus, the node apparatus supporting a different radio protocol than the apparatus; allocate transmission resources to the node apparatus, and control at least partly simultaneous data transmission of the apparatus and the node apparatus in downlink for providing inter-system carrier aggregation.

According to another aspect of the present invention, there is provided a method comprising: obtaining data to be transmitted in downlink by a first node apparatus; providing a part of the data to be transmitted in downlink to a second node apparatus, the second node apparatus supporting a different radio protocol than the first node apparatus; allocating transmission resources to the second node apparatus by the first node apparatus, and controlling at least partly simultaneous data transmission of the first node apparatus and the second node apparatus in downlink by the first node apparatus for providing inter-system carrier aggregation.

According to yet another aspect of the present invention, there is provided a system comprising: a first network node apparatus obtains data to be transmitted in downlink; the first network node apparatus provides a part of the data to be transmitted in downlink to a second node apparatus, the first node apparatus and the second node apparatus supporting different radio protocols; the first network node apparatus allocates transmission resources to the second node apparatus, and the first network node apparatus controls at least partly simultaneous data transmission of the first network node apparatus and the second node apparatus in downlink for providing inter-system carrier aggregation.

According to yet another aspect of the present invention, there is provided an apparatus comprising: means for obtaining data to be transmitted in downlink; means for providing a part of the data to be transmitted in downlink to a node apparatus, the node apparatus supporting a different radio protocol than the apparatus; means for allocating transmission resources to the node apparatus, and means for controlling at least partly simultaneous data transmission of the apparatus and the node apparatus in downlink for providing inter-system carrier aggregation.

According to yet another aspect of the present invention, there is provided computer program embodied on a computer-readable storage medium, the computer program comprising program code for controlling a process to execute a process, the process comprising: obtaining data to be transmitted in downlink by a first node apparatus; providing a part of the data to be transmitted in downlink to a second node apparatus, the second node apparatus supporting a different radio protocol than the first apparatus; allocating transmission resources to the second node apparatus, and controlling at least partly simultaneous data transmission of the first node apparatus and the second node apparatus in downlink for providing inter-system carrier aggregation.

### LIST OF DRAWINGS

Embodiments of the present invention are described below, by way of example only, with reference to the accompanying drawings, in which

FIG. 1 illustrates an example of a system;

FIG. 2 is a flow chart; and

FIG. 3 shows an example of an apparatus.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of access architectures to which the embodiments may be applied, a radio access architecture based on long term evolution (LTE) advanced, LTE-A, that is based on orthogonal frequency multiplexed access (OFDMA) in a downlink and a single-carrier frequency-division multiple access (SC-FDMA) in an uplink, and Time Division Synchronous

Code Division Multiple Access (TD-SCDMA) also known as UTRA/UMTS-TDD (UTRA=UMTS terrestrial radio access, UMTS=universal mobile telecommunications system, TDD=time division duplex) which in combination of time division code division multiple access (TD-CDMA) is known as UMTS-TDD or international mobile telecommunications (IMT) 2000 time-division (IMT-TD). However, embodiments are not restricted to such architectures.

TD-SCDMA combines code division multiple access (CDMA) and time division multiple access (TDMA) thus providing the spectrum efficiency of CDMA combined with the possibility to asymmetric data-transfer given by the TDMA frame structure. By dynamically adjusting the number of time slots for the uplink and downlink, it is possible to adjust the system to different data rate requirements on the downlink and uplink. In the TD-SCDMA, signals are spread as in wide-band CDMA (W-CDMA) but signalling is controlled by time division. By using TDMA, the need for duplex filters to separate transmitted signals from received signals may be avoided. Additionally, the TD-SCDMA utilises joint detection in reception and smart antennas.

The letter “S” in the TD-SCDMA stands for “synchronous” meaning that uplink signals are synchronised at the base station (or node B) receiver that is implemented by using timing adjustment.

LTE (Long Term Evolution) is a project of the 3rd Generation Partnership Project (3GPP). The LTE is a step toward 4th generation (4G) of radio technologies designed to increase capacity and speed of mobile telephone networks. Actually the LTE is a 3.9G technology since it does not fully comply with the IMT Advanced 4G requirements. The LTE is a set of enhancements to the Universal Mobile Telecommunications System (UMTS). E-UTRA is an air interface of 3GPP Release 8 LTE (UTRA=UMTS terrestrial radio access, UMTS=universal mobile telecommunications system). Some advantages obtainable by the LTE (or E-UTRA) are a possibility to use “plug and play” devices, as well as Frequency Division Duplex (FDD) and Time Division Duplex (TDD) in the same platform.

LTE advanced is a development of the LTE. It is currently being standardized in 3GPP Release 10.

The LTE (advanced) is based on orthogonal frequency multiplexed access (OFDMA) in the downlink and a single-carrier frequency-division multiple access (SC-FDMA) in the uplink.

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

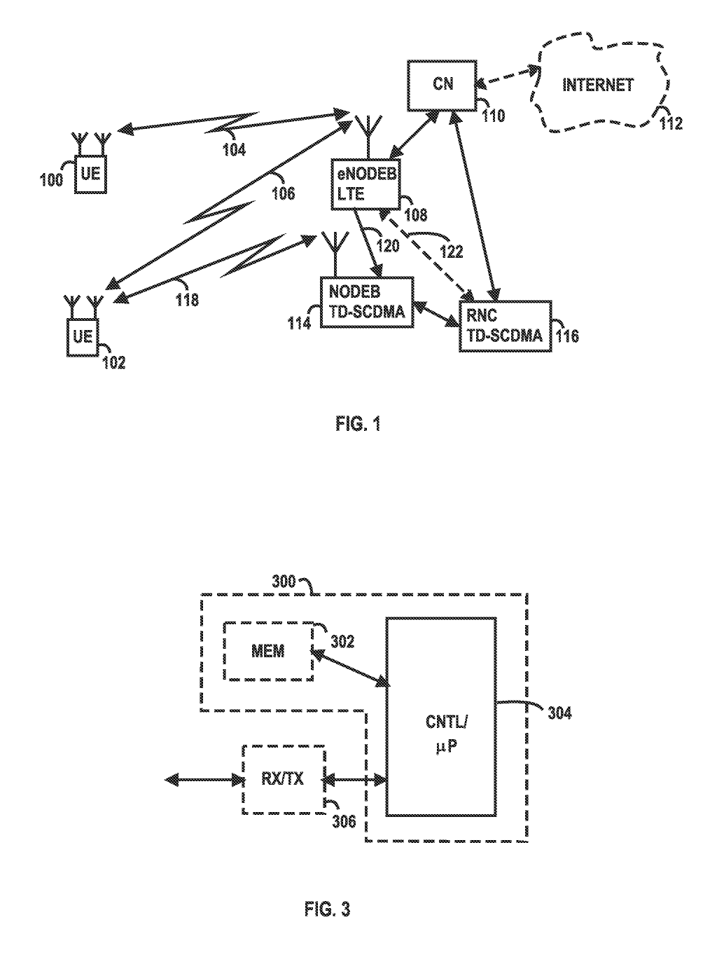

FIG. 1 is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1.

FIG. 1 shows a part of a radio access network of E-UTRA, LTE or LTE-advanced (LTE-A) or LTE/EPC (EPC=evolved packet core, EPC is enhancement of packet switched technology to cope with faster data rates and growth of Internet protocol traffic) in combination with a part of a TD-SCDMA system. The embodiments are not, however, restricted to the systems given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), wideband code division multiple access (WCDMA), code division multiple access (CDMA), groupe spécial mobile or global system for mobile communications (GSM), enhanced data rates for GSM evolution (GSM EDGE or GERAN), systems using ultra-wideband (UWB) technology and different mesh networks. Embodiments are especially suitable for co-existence networks of two or more systems.

FIG. 1 shows user devices 100 and 102 configured to be in a wireless connection on one or more communication channels 104, 106 in a cell with an LTE (e)NodeB 108 providing the cell. The physical link from a user device to an LTE (e)NodeB is called uplink or reverse link and the physical link from the LTE NodeB to the user device is called downlink or forward link.

The NodeB, or advanced evolved node B (eNodeB, eNB) in LTE-advanced, is a computing device configured to control the radio resources of a communication system it is coupled to. The (e)NodeB may also be referred to a base station, an access point or any other type of interfacing device including a relay station capable of operating in a wireless environment. The (e)NodeB may also be a virtual node, if real-world processing is carried out in a distant network processing centre coupled to a physical cell, by fiber cables, for instance.

The (e)NodeB includes at least one transceiver, for instance. From the transceivers of the (e)NodeB, a connection is provided to an antenna unit that establishes bidirectional radio links to user devices. The (e)NodeB is further coupled to a core network 110 (CN). Depending on the system, the counterpart on the CN side for the LTE may be a serving gateway (S-GW) (routing and forwarding user data packets), packet data network gateway (P-GW), for providing connectivity to user devices (UEs) to external packet data networks, or mobile management entity (MME), etc.

The user device 102 may also be coupled to a NodeB of TD-SCDMA system 114 via a radio connection 118. The TD-SCDMA NodeB is coupled to a TD-SCDMA radio network controller (RNC) 116 which typically controls several NodeBs. Typically, the distribution of functions between NodeB and RNC is according to that of WCDMA. The RNC is further coupled to a core network 110 which may be at least partly commonly used with the LTE system. In FIG. 1, the core network resources are shown as commonly used, but both systems may also have separate core networks. The TD-SCDMA NodeB may also be implemented as a distant network processing centre.

The communication systems are also able to communicate with other networks, such as a public switched telephone network or the Internet 112.

The (e)NodeB 108 and NodeB 114 may also be coupled to each other. In an embodiment, the (e)NodeB of the LTE 108 acts as a “master” node controlling data flow and simultaneous transmission. For emphasizing this, the connection 120 is shown to be a one-way connection (it should be appreciated that this connection may also be a two-way connection). Communication between these nodes may be implemented either over a fixed line or over air interface communication (OTAC). The (e)NodeB 108 and the RNC 116 may also be coupled to each other for example for controlling purposes. This is shown as an optional connection by a dotted arrow 122. An option is also that data transmission and signalling between these two systems are directed via the core network 110.

The user device illustrates one type of an apparatus to which resources on the air interface may be allocated and assigned, and thus any feature described herein with a user device may be implemented with a corresponding apparatus. The user device may also be called a subscriber unit, mobile station, remote terminal, access terminal, user terminal or user equipment (UE) just to mention but a few names or apparatuses.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented. It is obvious for a person skilled in the art that what is depicted is only an example of a part of a radio access systems and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. For example, the (e)NodeB 108 of FIG. 1 may provide any kind of these cells. A cellular radio system may be implemented as a multilayer network including several kinds of cells. Typically, in multilayer networks, one (e)NodeB provides one kind of a cell or cells, and thus a plurality of (e)NodeBs are required to provide such a network structure. Recently for fulfilling the need for improving the deployment and performance of communication systems, concept of “plug-and-play” (e)NodeBs has been introduced. Typically, in the LTE (advanced), a network which is able to use “plug-and-play” node (e)Bs, includes, in addition to Home (e)NodeBs (Home(e)nodeBs), a home node B gateway, or HNB-GW (not shown in FIG. 1). A HNB Gateway (HNB-GW), which is typically installed within an operator's network aggregates traffic from a large number of HNBs back to a core network through Iu-cs and Iu-ps interfaces.

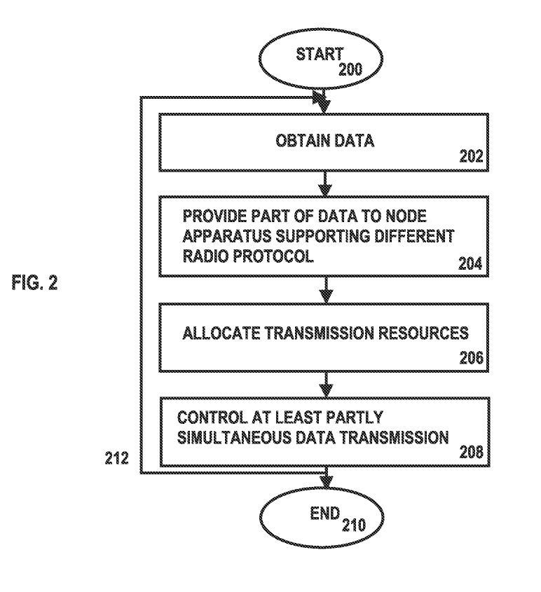

In the following, some embodiments of a method for providing inter-system carrier aggregation are explained in further detail by means of FIG. 2.

In TD-SCDMA, the peak data rate is limited due bandwidth available in a single frequency band. In LTE (-advanced), the solution to a similar kind of problem is to use carrier aggregation with multiple LTE carriers received or transmitted by a user device. In an embodiment, the principle of carrier aggregation is extended into an inter-system functionality.

An embodiment starts in block 200.

In block 202, data to be transmitted in downlink is obtained. The data is typically obtained from a core network. Normal data transmission routines may be applied.

In block 204, a part of the data to be transmitted in downlink is provided to a node apparatus supporting a different radio protocol than the apparatus itself.

In an example, the apparatus is an LTE (e)NodeB and the node apparatus supporting a different radio protocol is a TD-SCDMA NodeB.

In the case of carrier aggregation, the data to be transmitted is divided among node apparatuses involved in data transmission. This “data split” may be carried out by many different network elements. One option is a base station or node apparatus having control over transmitting nodes. This provides a close control point for downlink transmission in each radio access link from the network point of view. The data split may also be carried out in an RNC. However, in general, it is not desirable to add elements to the LTE system to keep the delays under control. Thus it may be more advantageous that an LTE (e)NodeB obtains data from the core network, carries out the data split and then forwards the part of the data to be transmitted via another node to this another node which in this example is a TD-SCDMA node.

In block 206, transmission resources are allocated to the node apparatus.

In the example used, carrier aggregation between TD-SCDMA and LTE TDD modes (time division LTE) is enabled by transmitting simultaneously from an LTE (e)NodeB and from a TD-SCDMA NodeB to a user device with the LTE (e)NodeB providing the TD-SCDMA NodeB information on suitable allocations for downlink transmission to avoid the user device having to transmit and receive simultaneously thus avoiding duplex filters (which are expensive and have a substantial size) or uplink and/or downlink interference. The interference may be remarkable due to the close proximity of spectra.

An alternative method for controlling timing is to use user device measurements for obtaining information on uplink and/or downlink allocation applied for a specific user device or for the cell the user device is coupled to. Thus, the user device may report TD-SCDMA allocations to an LTE (e)NodeB. This provides an option to avoid the need for providing information to the TD-SCDMA NodeB. Based on the measurements and/or reports, the LTE uplink and downlink may be scheduled in such a manner that conflicts between different radio access links may be avoided. If the uplink is used in the TD-SCDMA as well, the information on user device measurements of the LTE downlink may be provided to the TD-SCDMA NodeB.

The first option is better suited for co-located LTE TDD and TD-SCDMA nodes and when they have a common timing reference, whereas the latter one is better suited for a non-co-location case and especially when no common timing reference is provided. Having user device specific uplink and/or downlink allocation information in one system also enables more flexibility in downlink and/or uplink resource allocation in another system, in the case the systems have a sufficient frequency separation.

In block 208, at least partly simultaneous data transmission of the apparatus and the node apparatus in downlink is controlled for providing inter-system carrier aggregation.

As a part of a carrier aggregation, it is typically assumed that a user device is able to inform at least one of the node apparatuses on downlink signal quality in the uplink in order that the at least one node apparatus is able to base its scheduling decisions and link adaptation decisions on actual link quality. Actions which may be taken include muting or discontinuous transmission. Uplink controlling related to downlink transmission (channel quality indicator, rank indicator, precoding indicatior, acknowledge/non-acknowledge) may be taken care by using e.g. LTE uplink physical shared and/or control channels and/or TD-SCDMA uplink physical shared and/or control channels.

An option for data transmission purposes when a carrier aggregation is used, is to utilize an LTE(-A) downlink shared channel/dedicated physical channel together with TD-SCDMA downlink transmission in a dedicated physical channel.

A user device may be informed on allocated downlink resources by using corresponding (TD-CDMA or LTE(-A)) downlink control channels (for example, a broadcast channel, synchronization channel and/or paging channel). An option for uplink data and/or control transmission is to use LTE(-A or advanced) resources for providing a possibility to utilize a better feedback radio access link to control downlink radio access transmission.

A data flow between downlink radio access links may be optimized by the aid of user device measurements of a downlink radio access link signal quality that may be reported to an LTE (e)NodeB for obtaining a desired end to end quality.

The embodiment ends in block 210. The embodiment is repeatable and one option for repetition is shown with arrow 212. Other options are naturally also possible.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that transmitting and/or receiving may herein mean preparing a transmission and/or reception, preparing a message (or a part of a message) to be transmitted and/or received, or physical transmission and/or reception itself, etc on a case by case basis. Additionally, conveying information may mean initiation of a message (or a part of a message), or physical conveying, such as transmission, etc. depending on a current application.

In the following an example of a system where embodiments may be applied to is explained in further detail by means of FIG. 1. In the example, two radio protocols, namely the LTE (advanced) and TD-SCDMA are depicted. Naturally, other radio protocol combinations are also possible.

A core network 110 transmits data to an eNodeB of the LTE advanced system 108 to be transmitted in the downlink. The eNodeB of the LTE advanced system 108 “splits” the data and forwards to a NodeB of the TD-SCDMA system 114 the part of the data which is designed to be transmitted by this NodeB of the TD-SCDMA system. The eNodeB of the LTE system advanced 108 allocates transmission resources to the NodeB of the TD-SCDMA system 114 in such a manner that a user device 102 may avoid simultaneous transmission and reception. The eNodeB of the LTE system advanced 108 also controls the at least partly simultaneous data transmission of the eNodeB of the LTE system advanced 108 and the NodeB of the TD-SCDMA system 114 in the downlink for providing inter-system carrier aggregation which enhances data transmission rate.

An embodiment provides an apparatus which may be any node device, host, server or any other suitable apparatus able to carry out processes described above in relation to FIG. 2. FIG. 3 illustrates a simplified block diagram of an apparatus according to an embodiment especially suitable for interference management. It should be appreciated that the apparatus may also include other units or parts than those depicted in FIG. 3. Although the apparatus has been depicted as one entity, different modules and memory (one or more) may be implemented in one or more physical or logical entities.

The apparatus 300 may in general include at least one processor, controller or a unit designed for carrying out control functions operably coupled to at least one memory unit and to various interfaces. Further, a memory unit may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, element, unit, etc., may be configured as a computer or a microprocessor, such as a single-chip computer element, or as a chipset, including at least a memory for providing storage capacity used for arithmetic operation and an operation processor for executing the arithmetic operation.

As an example of an apparatus according to an embodiment, it is shown an apparatus, such as a node device or network element, including facilities in a control unit 304 (including one or more processors, for example) to carry out functions of embodiments according to FIG. 2. This is depicted in FIG. 3.

The apparatus may also include at least one processor 304 and at least one memory 302 including a computer program code, the at least one memory and the computer program code configured to, with the at least one processor, cause the apparatus at least to: obtain data to be transmitted in the downlink, provide at least part of the data to be transmitted in downlink to a node apparatus, the node apparatus supporting a different radio protocol than the apparatus, allocate transmission resources to the node apparatus, and control at least partly simultaneous data transmission of the apparatus and the node apparatus in downlink for providing inter-system carrier aggregation.

Another example of an apparatus comprises means (302) for obtaining data to be transmitted in the downlink, means (302, 304) for providing at least part of the data to be transmitted in downlink to a node apparatus, the node apparatus supporting a different radio protocol than the apparatus, means (302, 304) for allocating transmission resources to the node apparatus, and means (304) for controlling at least partly simultaneous data transmission of the apparatus and the node apparatus in downlink for providing inter-system carrier aggregation.

Yet another example of an apparatus comprises an obtainer configured to obtain data to be transmitted in the downlink, a provider configured to provide at least part of the data to be transmitted in downlink to a node apparatus, the node apparatus supporting a different radio protocol than the apparatus, an allocator configured to allocate transmission resources to the node apparatus, and a controller configured to control at least partly simultaneous data transmission of the apparatus and the node apparatus in downlink for providing inter-system carrier aggregation.

Embodiments of FIG. 2 may be carried out in a processor or control unit 304 possibly with aid of a memory 302 as well as a transmitter and/or receiver 306.

It should be appreciated that different units may be implemented as one module, unit, processor, etc, or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control depending on the implementation, etc. The apparatus may utilize a transmitter and/or receiver which are not included in the apparatus itself, such as a processor, but are available to it, being operably coupled to the apparatus. This is depicted as an option in FIG. 3 as a transceiver 306.

An embodiment provides a computer program embodied on a distribution medium, comprising program instructions which, when loaded into electronic apparatuses, constitute the apparatuses as explained above.

Another embodiment provides a computer program embodied on a computer readable medium, configured to control a processor to perform embodiments of the methods described above.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
obtain data to be transmitted in downlink;
provide a part of the data to be transmitted in downlink to a node apparatus, the node apparatus supporting a different radio protocol than the apparatus;
allocate transmission resources to the node apparatus, and
control at least partly simultaneous data transmission of the apparatus and the node apparatus in downlink for providing inter-system carrier aggregation.

2. The apparatus of claim 1, wherein the apparatus supports long term evolution radio protocol and the node apparatus supports time division synchronous code division multiple access radio protocol.

3. The apparatus of claim 1, further configured to:
carry out division of data to parts and forwarding the part of the data to be transmitted via the node apparatus supporting different radio protocol than the apparatus to this another node apparatus.

4. The apparatus of claim 1, wherein the allocation of transmission resources is carried out in such a manner that a user device avoids simultaneous transmission and reception thus avoiding a need for a duplex filter.

5. The apparatus of claim 1, wherein the at least partly simultaneous transmission is carried out by utilizing a long term evolution physical downlink shared channel together with time division synchronous code division multiple access transmission in a shared or dedicated physical downlink channel.

6. The apparatus of claim 1, wherein instructions are provided to the node apparatus supporting a different radio protocol, when data transmission for the user device is able to proceed in time domain.

7. The apparatus of claim 1, the apparatus comprising a server, host, node device or a user device.

8. A computer program comprising program instructions which, when loaded into the apparatus, constitute the modules of claim 1.

9. A method comprising:
obtaining data to be transmitted in downlink by a first node apparatus;
providing a part of the data to be transmitted in downlink to a second node apparatus, the second node apparatus supporting a different radio protocol than first node apparatus;
allocating transmission resources to the second node apparatus by the first node apparatus, and
controlling at least partly simultaneous data transmission of the first node apparatus and the second node apparatus in downlink by the first node apparatus for providing inter-system carrier aggregation.

10. The method of claim 9, wherein the first node apparatus supports long term evolution radio protocol and the second node apparatus supports time division synchronous code division multiple access radio protocol.

11. The method of, claim 9 further comprising:
carrying out division of data to parts and forwarding the part of the data to be transmitted via the second node apparatus to the second node apparatus.

12. The method of claim 9, wherein the allocation of transmission resources is carried out in such a manner that a user device avoids simultaneous transmission and reception thus avoiding a need for a duplex filter.

13. The method of claim 9, wherein the at least partly simultaneous transmission is carried out by utilizing a long term evolution physical downlink shared channel and/or dedicated physical channel together with time division synchronous code division multiple access downlink transmission in a shared or dedicated physical downlink channel transport channel.

14. The method claim 9, wherein instructions are provided to the second node apparatus, when data transmission for the user device is able to proceed in time domain.

15. A system comprising:
a first node apparatus obtains data to be transmitted in downlink;
the first node apparatus provides a part of the data to be transmitted in downlink to a second node apparatus, the first node apparatus and the second node apparatus supporting different radio protocols;
the first node apparatus allocates transmission resources to the second node apparatus, and
the first node apparatus controls at least partly simultaneous data transmission of the first node apparatus and the second node apparatus in downlink for providing inter-system carrier aggregation.

16. The system of claim 15, wherein the first node apparatus supports long term evolution radio protocol and the second node apparatus supports time division synchronous code division multiple access radio protocol.

17. The system of claim 15, further comprising:
carrying out division of data to parts and forwarding the part of the data to be transmitted via the second node apparatus to the second node apparatus.

18. An apparatus comprising:
means for obtaining data to be transmitted in downlink;
means for providing a part of the data to be transmitted in downlink to a node apparatus, the node apparatus supporting a different radio protocol than the apparatus;
means for allocating transmission resources to the node apparatus, and
means for controlling at least partly simultaneous data transmission of the apparatus and the node apparatus in downlink for providing inter-system carrier aggregation.

19. A computer program embodied on a computer-readable storage medium, the computer program comprising program code for controlling a process to execute a process, the process comprising:
obtaining data to be transmitted in downlink by a first node apparatus;
providing a part of the data to be transmitted in downlink to a second node apparatus, the second node apparatus supporting a different radio protocol than the first apparatus;
allocating transmission resources to the second node apparatus, and
controlling at least partly simultaneous data transmission of the first node apparatus and the second node apparatus in downlink for providing inter-system carrier aggregation.

20. The computer program of claim 19, wherein the first node apparatus supports long term evolution radio protocol and the second node apparatus supports time division synchronous code division multiple access radio protocol.

21. The computer program of claim 19, the process further comprising:
carrying out division of data to parts and forwarding the part of the data to be transmitted via the second node apparatus to the second node apparatus.

22. The computer program of claim 19, wherein the allocation of transmission resources is carried out in such a manner that a user device avoids simultaneous transmission and reception thus avoiding a need for a duplex filter.

23. The computer program of claim 19, wherein the at least partly simultaneous transmission is carried out by utilizing a long term evolution physical downlink shared channel and/or dedicated physical channel together with time division synchronous code division multiple access downlink transmission in a shared or dedicated physical downlink channel transport channel.

24. The computer program of claim 19, wherein instructions are provided to the second node apparatus supporting a different radio protocol, when data transmission for the user device is able to proceed in time domain.
